(19) United States
(12) Patent Application Publication
(10) Pub. No.: US 2004/0057253 A1
(43) Pub. Date: Mar. 25, 2004

(54) Optical backplane connector with positive feedback and mode conversion

(75) Inventors: Casimer M. DeCusatis, Poughkeepsie, NY (US); Cameron J. Brooks, Elmsford, NY (US); Lawrence Jacobowitz, Wappingers Falls, NY (US); John U. Knickerbocker, Wappingers Falls, NY (US)

Correspondence Address: INTERNATIONAL BUSINESS MACHINES CORPORATION, DEPT. 18G, BLDG. 300-482, 2070 ROUTE 52, HOPEWELL JUNCTION, NY, 12533, US

(73) Assignee: International Business Machines Corporation, Armonk, NY

(21) Appl. No.: 10/254,706

(22) Filed: Sep. 25, 2002

(51) Int. Cl. G02B 6/00

(52) U.S. Cl. 362/581; 362/551

(57) ABSTRACT

A connector system for fiber optic cables employs an interface module located between the cable connector and the system component receiving the optical signals that converts the single-mode light on the cable to a mixture of modes that fill a multi-mode waveguide on the system board, thereby reducing modal noise and differential mode delay. A particular connector produces an electrical signal reflecting whether the optical connection is within specifications.

### TECHNICAL FIELD

The field of the invention is that of connecting optical fibers, in particular connecting fiber ribbon cables to modules on circuit boards.

### BACKGROUND OF THE INVENTION

A need has been projected for optical backplane interconnects in large servers (5-20 Terabyte capacity) within the next 2-5 years.

It has long been recognized that long distance (>1 km) fiber optic links using either 850, 1300 nm, or 1500 nm laser sources may create the need for mode conditioning. For example, the IEEE 802.3z Gigabit Ethernet standard specifies the use of offset launch mode conditioners when using 1300 nm laser sources (optimized for singlemode fiber) over a multimode cable plant; failure to do so leads to excessive modal noise and differential mode delay, including phase noise which creates bit error rate floors (see for example special issue of Optical Engineering on Fiber Optic Data Communications, vol. 37, no. Dec. 12, 1998). The same problems occur in optical backplanes, even though the distances are much shorter. However, the offset launch condition described previously is not extendable to backplanes, since the mechanical tolerances achievable when plugging a printed circuit card into a backplane are not adequate (less than 10 microns tolerance are required for the solution used in long fibers).

The same requirement for hyper-accuracy exists for other possible mode conditioning methods, including the use of lens systems to redistribute the optical signals in multimode fiber. Furthermore, this approach is not easily extendable to multimode waveguides which have a rectangular geometry and much larger cores (>100 microns, vs. typical optical fiber cores of 50 and 62.5 micron diameter).

Various types of optical fiber space transformers have been suggested to allow large arrays of optical fiber to escape from confined spaces such as card edges or MCM packages (see for example C. DeCusatis, L. Jacobowitz, and M. Ecker, “Substrate embedded pluggable receptacle for connecting clustered optical cables to a multichip module”, U.S. Pat. No. 5,333,225 issued July 1994). This work does not address the problems of mode conversion or mode mixers which may be required in this application.

When optical fibers are used to replace copper wiring for printed circuit boards (PCBs) in computer and networking equipment, it is important to insure that an optical connection has actually been made when inserting a card into a backplane. Tracking down a faulty connection can consume a great deal of time. Electrical connectors can provide feedback such as illuminating an indicator lamp when they are plugged into a backplane; conventional optical connectors cannot accomplish the same level of confirmation when a good connection is made. Often, it is desirable to install cards in a backplane before the rest of the optical link is functional (lasers, receivers, etc) with the expectation that the optical connection will work when required. This is done to minimize service time, or to avoid potential laser eye safety issues (powering on the optics while unprotected service people are in the area). If electrical connectors are located adjacent to the optical connectors, then positive latching of the electrical connectors does not necessarily correspond with positive latching of the optical connectors. Unless optical backplane connectors can provide the same level of assurance that a connection has been made that is currently provided by electrical connectors, the adoption of optical technology in the backplane will be inhibited. An objective of this invention is to provide a positive retention signal (indicator lamp) when an optical backplane connection is made; furthermore, it is possible to determine the quality of the optical connection based on the feedback signal from this connector. The connector also does not require light to be provided from elsewhere in the system, nor does it require expensive active optical components built into the connector body.

There is thus a need in the art for apparatus that permits removable connections for optical cables that are manufacturable and permit adequate alignment without time-consuming alignment procedures. In addition, there is a need for apparatus that permits optical signals to be mode mixed when traversing a mixture of multi-mode or single mode media in an optical backplane.

### SUMMARY OF THE INVENTION

The invention relates to an integrated mode mixer suitable for printed circuit board (PCB) to backplane connectors which addresses the problem of phase noise.

A feature of the invention is an interface between the cable connector and the system component that converts the single-mode light on the cable to a mixture of modes that fill a multi-mode waveguide on the system board.

A feature of the invention is the location of the mode-mixing interface in a module bonded to a substrate.

Another feature of the invention is the location of the mode-mixing interface in an adapter between a module bonded to a substrate and the cable.

Another feature of the invention is the shaping of the fiber pitch from the cable pitch to a module pitch.

Another feature of the invention is a fiber connector having a metal contact that forms a conductive path when the connector is properly seated.

Another feature of the invention is a fiber connector having a metal contact that alters a capacitance value when the connector is properly seated.

### BRIEF DESCRIPTION OF THE DRAWINGS

FIG. 1 shows in partially pictorial, partially schematic form, a system using the invention.

FIG. 2 shows a portion of the system of FIG. 1.

FIG. 3 shows in exploded form an interface module for use with the invention.

FIGS. 4A-4E show coupling mechanisms for use with the invention.

FIGS. 5A-5B show feedback connectors for use with the invention.

FIGS. 6A-6B show additional feedback connectors for use with the invention.

### DETAILED DESCRIPTION

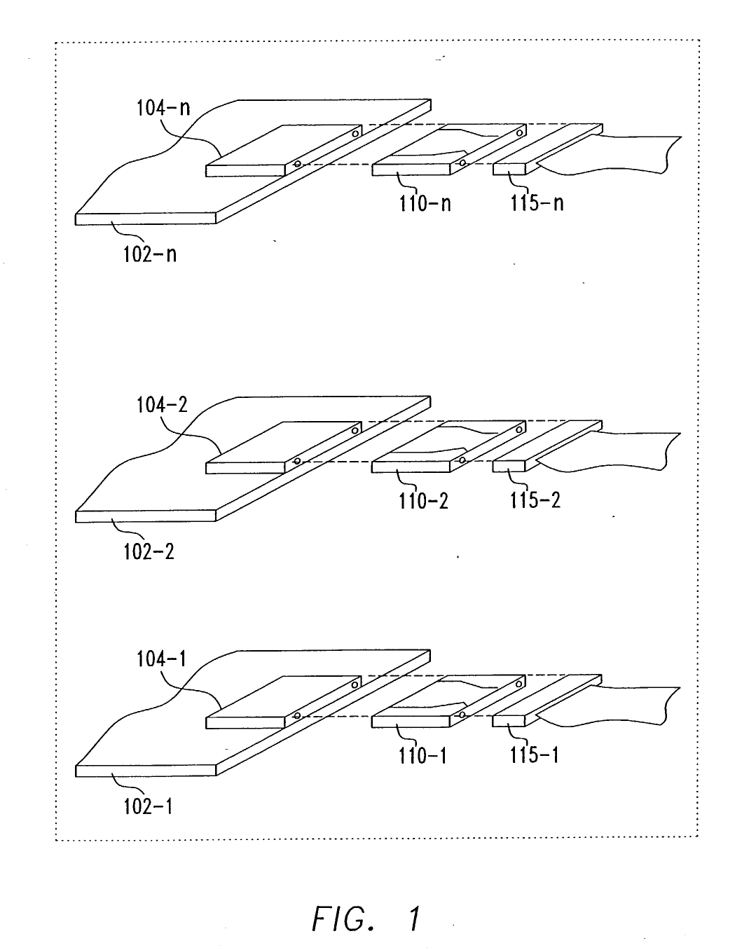

Referring now to FIG. 1, there is shown a simplified version of an electronic circuit system, such as that used in routing signals within large-scale computer architectures and the like. The portion shown is a set of connections between individual boards or units in the system. Boards 102-i, each containing a representative logic or signal processing module 104-1, are connected by fiber optic ribbon cables 115-i. The fibers in such cables are typically single-mode and the waveguides formed in substrates by lithographic techniques are multi-mode. The optical fiber core diameter is much smaller than nominal waveguide dimensions of 50-250 microns, while the fiber outer diameter is also less than 125 microns. Diameters for singlemode fiber are 9 microns, multimode fibers are 50 or 62.5 microns, and most plastic fibers are 100 microns or less.

The examples illustrated can be applied to both 850 nm lasers and to 1300 nm or 1550 nm lasers over multimode fiber/waveguides. In the former case mode conditioning may be required to avoid preferential mode excitation. In the latter case, mode conditioning may be required to avoid differential mode delay. Both embodiments require similar geometries for implementation. Those skilled in the art will readily be able to adjust the examples illustrated to suit their needs.

In order to provide for efficient coupling between single-mode fibers and multi-mode fibers or waveguides, a tapered or partially spherical extension is fabricated on the end of the waveguide where it plugs into the backplane; the specific geometry depends on the wavelengths of interest. This taper can be lithographically fabricated (for example, in a silicon oxy-nitride waveguide), or attached afterwards as a glass or molded plastic feature. Light from the input fiber/waveguide diverges strongly upon entering the mode mixing region, and each input light ray undergoes at least one and preferably multiple reflections before coupling into a supported mode of the output multimode fiber/waveguide. The result of this is that all modes in the output waveguide tend to be excited uniformly and modal dispersion is minimized, so that longer distances across the backplane and lower bit error rates can be achieved.

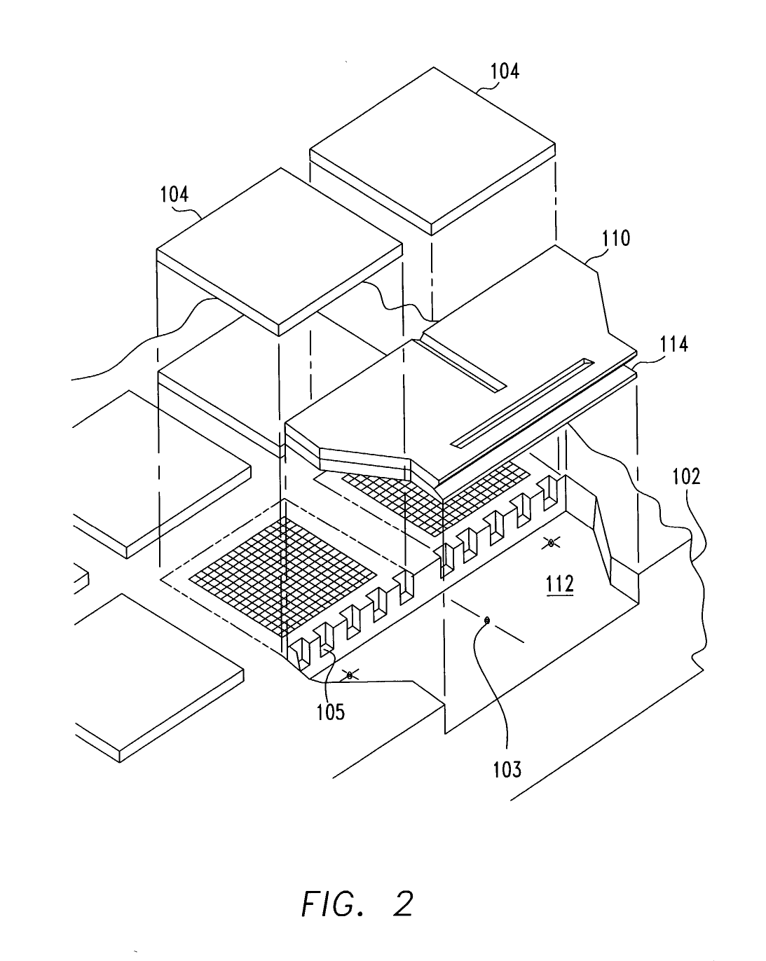

Referring now to FIG. 2, there is shown in perspective a detail of a system such as that shown in FIG. 1, in which substrate 102 supports a set of modules 104, optical, electronic or hybrid. At the center of the Figure, two such modules 104 receive optical radiation from a ribbon cable not shown that passes through coupling member 110. Coupler 110 receives radiation from the ribbon cable and passes it to units 104, changing the pitch of individual signal channels (fibers or waveguides) as required and also processing the spatial distribution of radiation to provide for efficient coupling. Member 110 fits into a recess 112 formed in substrate 102 (having alignment holes 103) and passes the radiation through a set of notches 105. Preferably, a notch 105 will mate with a corresponding projection on the surface of member 110, the radiation passing through that area. Alternatively, the alignment could be provided by mechanical fixtures that are separate from the optical transmission, but the version of the previous sentence is preferred.

Modules 104 are mounted by any convenient means to electrical contacts on board 102 and aligned by techniques known to those skilled in the art. Since modules 104 and 110 are permanently mounted, alignment is less difficult that it would be if they were repeatedly removed and replaced. An important benefit of this approach is that it allows for lithographic tolerances in the placement of optical interfaces within a circuit board system or a multichip module package.

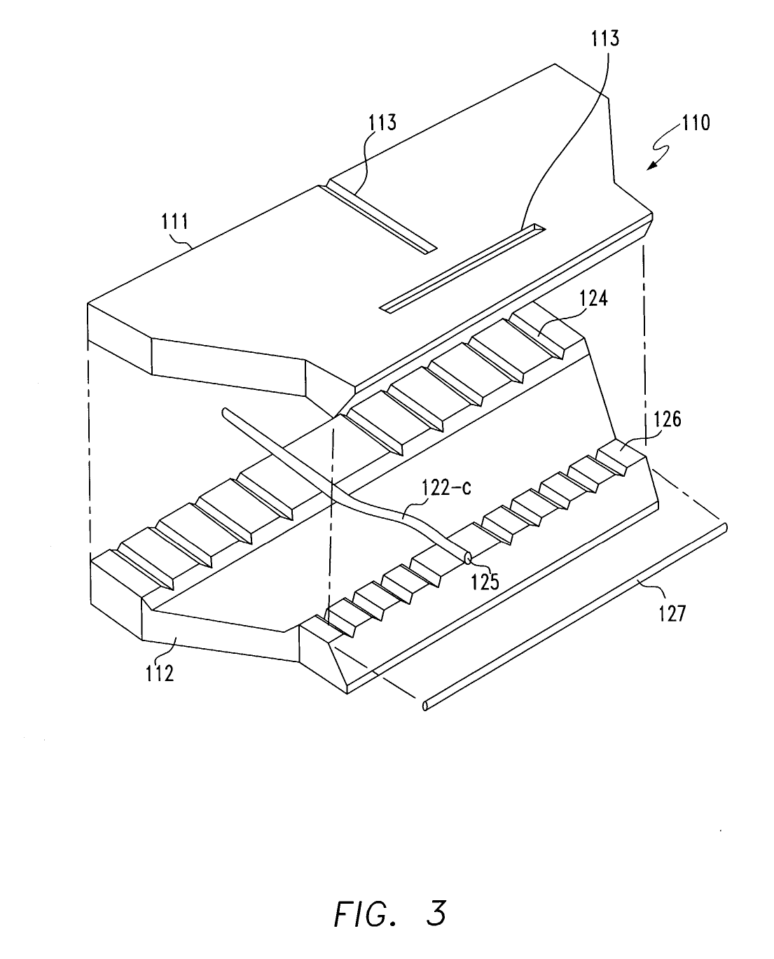

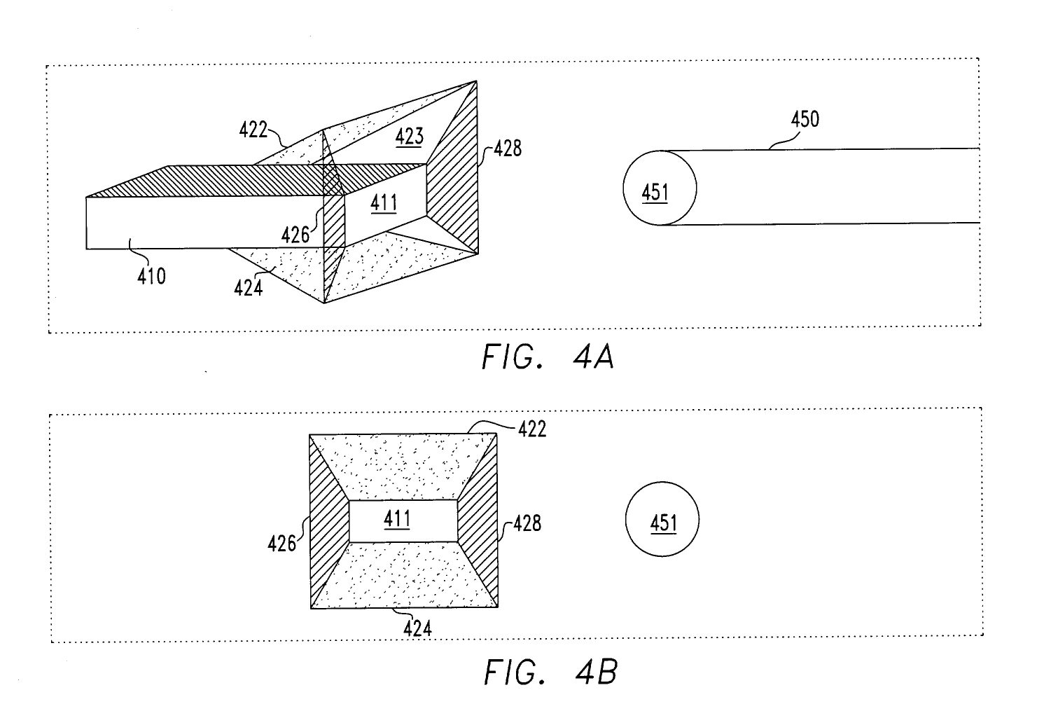

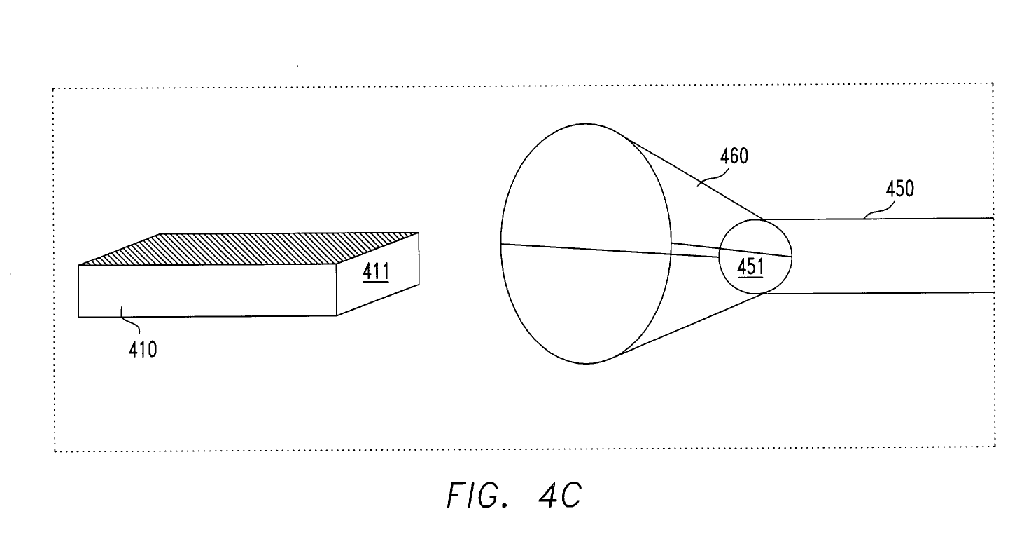

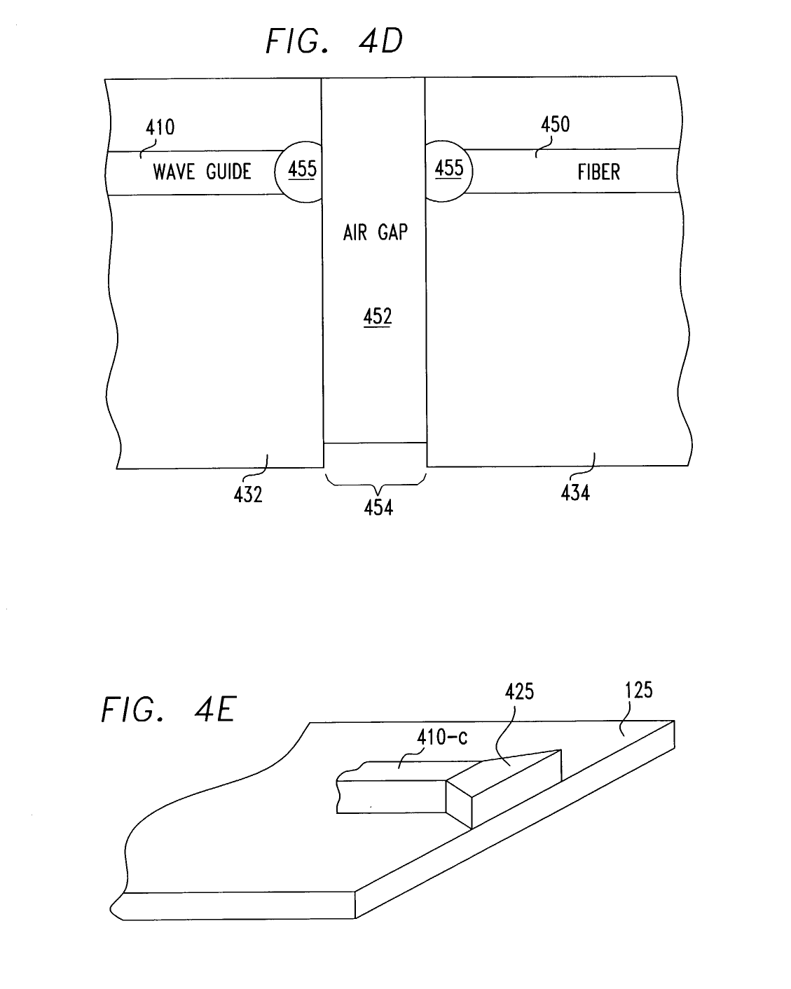

At the right side of coupler 110, a notch 114 provides for coarse alignment of the fiber ribbon cable. Coupler 110 is shown in more detail in FIG. 3, in which a bottom plate 112 contains a set of notches 124 with a pitch matched to the modules 104 and a second set of notches 126, with a pitch matched to the cable. One fiber 122-i is shown as an example of a connection between a notch 126 and 124. It is referred to as a mode transforming unit and converts single-mode radiation from the cable into a number of modes. At the right end of fiber 122-i, a circle 125 at a first interface represents schematically one of a set of mode transition couplers shown in the following FIGS. 4A-4E. An optional bulk lens 127 may be used if desired as a cylindrical lens to focus light diverging from a cable fiber into fiber 122-i. Optionally, coupler 125 could be located at a second interface between coupler 110 and unit 104.

A set of transition couplers is shown in FIGS. 4A-4E. Beginning with FIGS. 4A and 4B, waveguide 410 is illustratively formed by lithographic techniques from Silicon oxy-nitride on a silicon substrate. Four planar reflective members 422 and 424 on the top and bottom, respectively and 426 and 428 on the left and right are bonded by conventional techniques to waveguide 410. The taper of the four plates is set to reflect radiation diverging from face 451 of fiber 450 on the right of the Figure into face 411 of the waveguide, with some of the radiation possibly entering through one of the faces of the waveguide. It is preferable, but not required, to have several reflections to increase the amount of mode mixing. Although in the front view in FIG. 4B it appears that member 422 is bonded to member 428 at their common edge, it can be seen in FIG. 4A that there is no common edge. Numeral 423 denotes an air gap between member 422 and 428, which touch at only one point. Similarly, numeral 427 denotes a gap between members 428 and 424. If desired, the four sides could be bonded at their common edges for increased strength. Those skilled in the art will appreciate that the arrangement illustrated is adapted for radiation traveling from fiber 450 to the waveguide.

Referring to FIG. 4C, there is shown an arrangement adapted for radiation traveling from face 411 of a waveguide 410 to face 451 of fiber 450 and being collected by cone 460. A cone could be placed on fiber 450 in FIG. 4A, if the radiation is to travel in both directions.

Next, in FIG. 4D, there is shown a symmetric arrangement between waveguide 410 and a fiber 450. Two hemispherical lenses 455 focus radiation from one transmission member to the other. An air gap 452 having a dimension 454 (about 100 microns) separates the two lenses, which preferably have a focal length such that radiation is focused into the other lens.

FIG. 4E illustrates another alternative, in which the transition coupler is formed by lithographic techniques at the same time as the waveguide 410. In this case, substrate 112 of FIG. 3 is a silicon or other substrate suited for lithographic operations. Support 125 for V-notches is replaced by support 125 in FIG. 4E, in which a fiber 410-i replacing fiber 122-i has a transition member 425 formed at the same time as the waveguide. Member 425 tapers from an initial width on its face to a waveguide width that is the same as waveguide 410. This version lacks the vertical collection properties of the versions of FIGS. 4A-4C, but has the advantage of the use of well known semiconductor manufacturing techniques. Advantageously, member 425 could be placed at the interface of a module 104 in FIG. 1 or 2 in a case where the module 104 has the same pitch as the fiber cable, so that the spatial pitch transformation of unit 110 is not needed. In a configuration such as that shown in FIGS. 1 and 2, coupler 110 will be said to be adjacent the module 104. In a configuration such as that in FIG. 4E, the transition member will be said to be located within the system module 104.

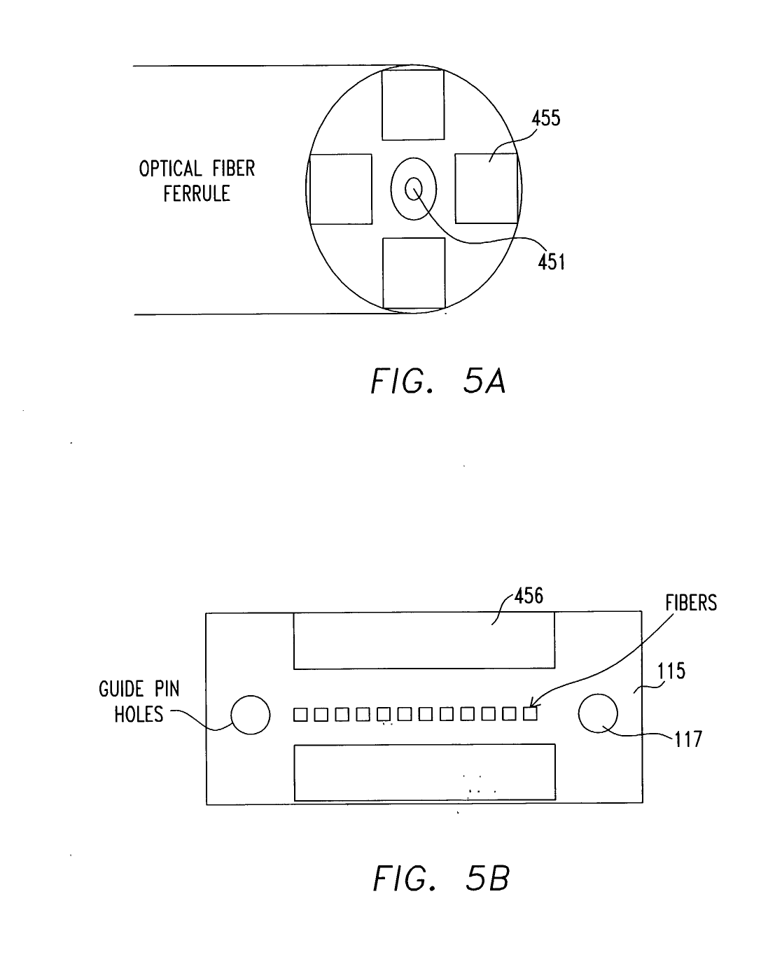

FIGS. 5A and 5B show contacts for a feedback mechanism in a single fiber and a ribbon connector, respectively. Optical fibers with metallized coatings are available today from various commercial sources; and it is possible to metallize other surfaces of the connector body as well, such as the front face of the ferrules. Many connectors feature either a flat polish or an extreme convex radius (essentially flat) to enable glass-to-glass physical contact between the fiber cores. In a typical spring-loaded duplex optical connector, for example, a surface area of over 300 microns radius can be brought into physical contact by this means. The optical fiber core diameter is much smaller (diameters for singlemode fiber are 9 microns, multimode fibers are 50 or 62.5 microns, and most plastic fibers are 100 microns or less), while the fiber outer diameter is also less than 125 microns. Thus, there is extra surface area in the connector which makes physical contact at the same time as the optical fibers. One embodiment of this invention is to metallize a small area 455 on the ferrule front faces, so that when the ferrule cores are brought into optical contact the metal comes into electrical contact as well. The metal coatings required are sufficiently thin as to not present any impediment to the optical plugging; in fact, a spring loaded connector force will typically slightly deform the ferrule end face in any event. The metal surface may be patterned as shown in FIG. 5A to provide a target for the connection alignment, for example insuring rotational symmetry. A corresponding example for a multifiber ribbon cable is shown in FIG. 5B. The technique applies to both ceramic ferrules and thermoplastic Multifiber Termination ferrules, as well as other materials, since the metal flash coating is easily deposited on a wide range of substrates. In this case, electrical contact is made at the same time as optical contact, and a low voltage/current circuit (referred to as an indication circuit) may be completed across the optical connector. This circuit can be used to actuate a control circuit for an indicator lamp. For example, the lamp may turn green when the connector is inserted properly, and red when it is not. Any dirt or significantly sized contamination which prevents the surfaces from achieving optical contact will also prevent the electrical circuit from completing. Thus, the connector warns of poor attachment due to dirt or other problems.

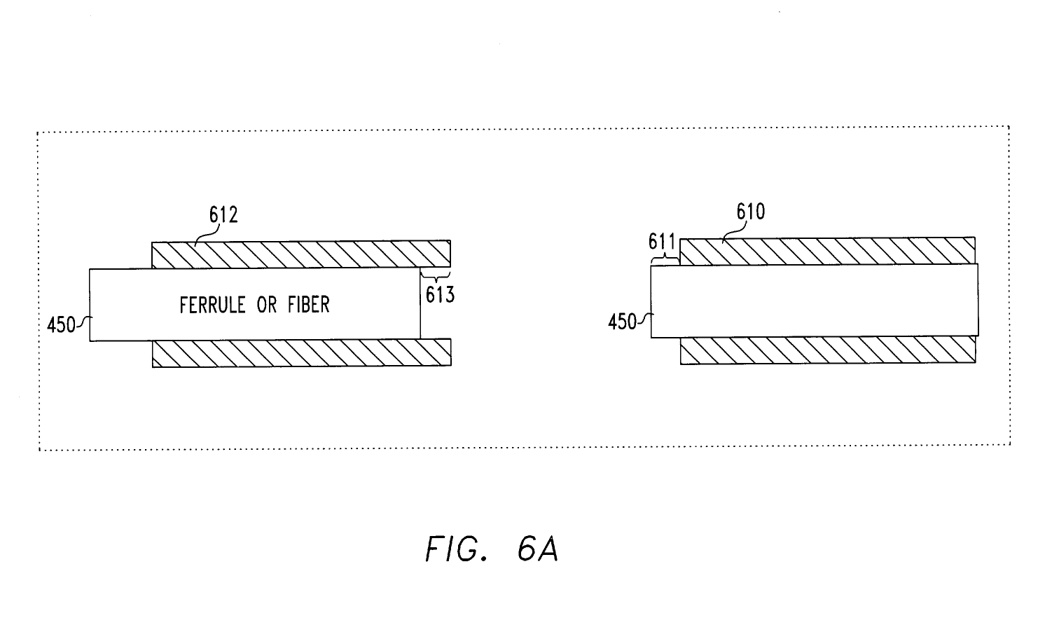

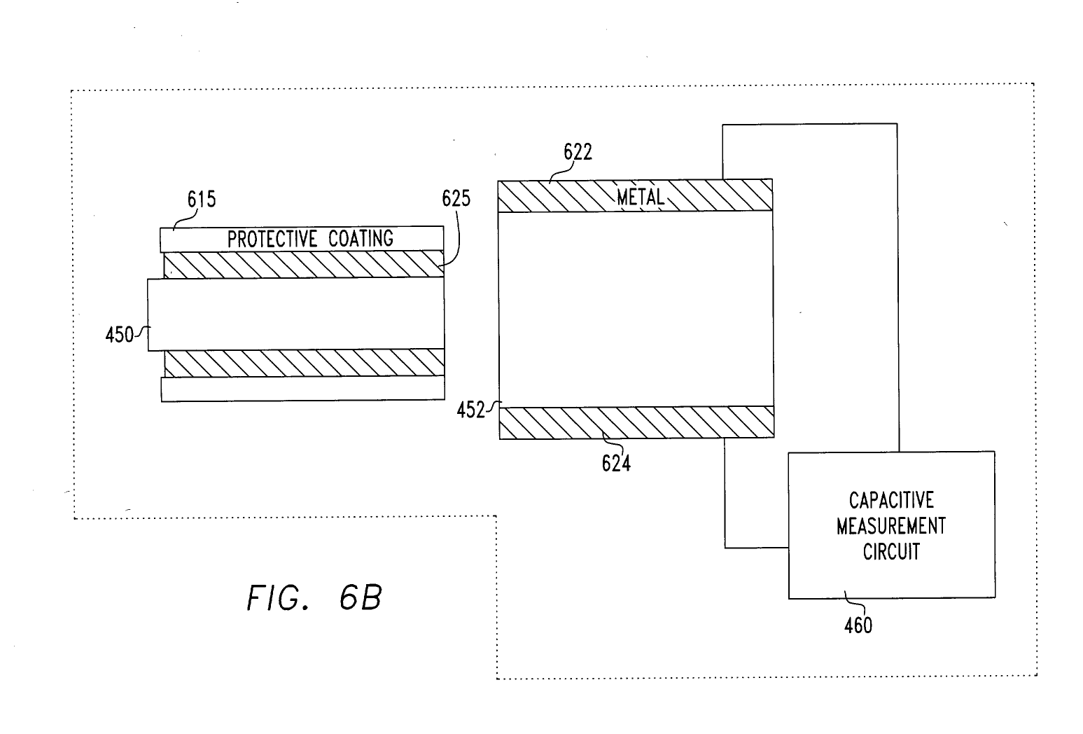

In another embodiment, shown in FIG. 6A, metal coating 612 may be slightly extruded from the surface of one ferrule with corresponding coating 610 being slightly retarded from the surface of another. This is accomplished using standard photolithographic patterning methods, or by polishing or grinding the ferrule or metal accordingly. This bayonet method insures that the electrical contact signal is only generated when the ferrules are in physical contact. The distance between the faces of the fibers will be distance 613 minus distance 611. It will be a design choice to set these two distances nominally equal or to design the spacing such that there is an air gap between the two fiber faces.

In another embodiment, an electrical circuit is connected which measures the capacitance of the interface. Circuit 460 measures the capacitance between two electrically separate metal members 622 and 624. When fiber 450, carrying metal ferrule 625, is brought into position, the capacitance will change in a predictable manner. Should the fibers not make contact, the capacitance measurement is used to determine the spacing between the metal contacts. Since the metal spacing also determines the relative spacing of the optical fibers, the connection loss may also be estimated and an indication may be provided when the gap/loss exceeds a limit. This is especially useful in multifiber connectors, where true physical contact is difficult to achieve across the entire fiber array. By providing feedback on when a good plug is made, this invention may also enable the relaxing of tolerances in the optical connectors and a corresponding reduction in cost.

Such a system is particularly useful in parallel optical links with large arrays of optical fiber ribbon, because the tolerance runout on large array connectors makes it much more difficult to insure physical contact across all fibers in the array. Individual fibers in the array can be monitored for optical contact by connecting circuit 460 to each connector in sequence. The system operator can measure and correlate the electrical capacitance measurements at this interface with the expected optical loss, so that this invention can function as an indirect optical power meter. It should also be noted that the embodiment of this invention which uses metallic coated fibers also applies to butt coupling connectors which do not use ferrules, or to those connectors based on evanescent coupling rather than butt coupling. A sufficient thickness of metal coating should be applied to prevent wearing away of the metal after a large number of plugs (a 20 micron aluminum coating is estimated to withstand 200 plug cycles without accumulating excessive wear). Another possible embodiment involves using a protective overcoating 615 on top of the metal, with a known thickness and dielectric constant. The coating acts to protect the metal from wear and shorting, and still permits capacitive measurements of the connector separation.

While the invention has been described in terms of a single preferred embodiment, those skilled in the art will recognize that the invention can be practiced in various versions within the spirit and scope of the following claims.

What is claimed is:

1. An optical interface module for coupling optical radiation between a connector containing at least two optical fibers and at least two corresponding optical transmitting members in a system module comprising:
a first interface coupled to said connector; and
a second interface coupled to said at least two corresponding optical transmitting members; in which at least one of said first and second interfaces includes a mode transforming unit adapted for coupling radiation between different modes.

2. An optical interface module according to claim 1, in which said mode transforming unit is located adjoining said system module at said second interface.

3. An optical interface module according to claim 2, in which said two corresponding optical transmitting members are rectangular waveguides disposed on a substrate and said mode transforming unit is a length of multi-mode optical fiber, whereby radiation from said connector is coupled into a plurality of modes in said multi-mode optical fiber.

4. An optical interface module according to claim 3, in which said mode transforming unit is a cone of reflective material disposed about said multi-mode optical fiber at said first interface, whereby radiation from said connector is coupled into a plurality of modes in said multi-mode optical fiber.

5. An optical interface module according to claim 2, in which said two corresponding optical transmitting members are rectangular waveguides disposed on a substrate and said mode transforming unit is a set of reflective plates disposed about said waveguides, whereby radiation from said connector is coupled into a plurality of modes in said waveguides.

6. An optical interface module according to claim 5, in which said rectangular waveguides project out from said substrate and said mode transforming unit is a set of reflective plates disposed about said waveguides.

7. An optical interface module according to claim 6, in which said set of reflective plates are disposed about three sides of said waveguides.

8. An optical interface module according to claim 2, in which said two corresponding optical transmitting members are rectangular waveguides disposed on a substrate and said mode transforming unit is a tapered wedge tapering from an initial width to a waveguide width matched to said waveguides, whereby radiation from said connector is coupled into a plurality of modes in said waveguides.

9. An optical interface module according to claim 1, in which said mode transforming unit is located adjoining said connector at said first interface and is adapted for transforming single-mode radiation from said connector into multi-mode radiation in said at least two optical fibers.

10. An optical interface module according to claim 9, in which said mode transforming unit is a cone of reflective material disposed about said multi-mode optical fiber at said first interface, whereby radiation from said connector is coupled into a plurality of modes in said multi-mode optical fiber.

11. An optical interface module according to claim 9, in which said mode transforming unit includes a cylindrical lens common to said at least two optical fibers and positioned at said first interface.

12. An optical interface module according to claim 11, in which said mode transforming unit is a cone of reflective material disposed about said multi-mode optical fiber at said first interface, whereby radiation from said connector is coupled into a plurality of modes in said multi-mode optical fiber.

13. An optical interface module for coupling optical radiation between a connector containing at least two optical fibers and at least two corresponding optical transmitting members in a system module comprising:
a first interface coupled to said connector in which said connector has a set of corresponding conductors associated with each fiber that produce an electrical effect when said connectors are properly engaged.

14. An optical interface module according to claim 13, in which said corresponding conductors make electrical contact with an indication circuit when said connectors are properly engaged.

15. An optical interface module according to claim 13, in which said corresponding conductors establish a reference capacitance value in an indication circuit when said connectors are properly engaged.
